(19) United States
(12) Patent Application Publication
(10) Pub. No.: US 2010/0056404 A1
(43) Pub. Date: Mar. 4, 2010

(54) METHOD FOR TREATING HYDROGEN SULFIDE-CONTAINING FLUIDS

(75) Inventor: Charles Bullick Talley, Aurora, CO (US)

Correspondence Address: SHERIDAN ROSS PC, 1560 BROADWAY, SUITE 1200, DENVER, CO, 80202, US

(73) Assignee: MICRO PURE SOLUTIONS, LLC, Roselle, IL (US)

(21) Appl. No.: 12/550,910

(22) Filed: Aug. 31, 2009

Related U.S. Application Data
(60) Provisional application No. 61/093,153, filed on Aug. 29, 2008.

(51) Int. Cl. C09K 8/524; E21B 19/00

(52) U.S. Cl. 507/239; 507/200; 507/259; 507/266; 507/277; 166/90.1

(57) ABSTRACT

The present invention relates generally to a method for treating hydrogen sulfide-containing fluids, more specifically to a method of treating hydrogen sulfide associated with petroleum and/or natural gas production.

### CROSS REFERENCE TO RELATED APPLICATION

The present application claims the benefits of U.S. Provisional Application Ser. No. 61/093,153, filed Aug. 29, 2008, of the same title, which is incorporated herein by this reference.

### FIELD OF THE INVENTION

The present invention relates generally to a method for treating hydrogen sulfide-containing fluids, more specifically to a method of treating hydrogen sulfide associated with petroleum and/or natural gas production.

### BACKGROUND OF THE INVENTION

Hydrogen sulfide is a highly toxic, flammable gas commonly associated with petroleum and/or natural gas production. Low levels of hydrogen sulfide in the parts-per-million range is toxic to most living organisms and corrosive to most petroleum and natural gas processing and transporting equipment; for this reason, hydrogen sulfide is typically removed from petroleum and natural gas. Typical hydrogen sulfide removal methods, such as amine scrubbing, chelation, and burning, utilize and/or produce regulated materials having health and/or environmental concerns.

### SUMMARY OF THE INVENTION

The present invention is directed to a hydrogen sulfide removal method that comprises contacting environmentally friendly materials with a hydrogen sulfide-containing material to produce environmentally friendly sulfur-based products.

One aspect of the present invention comprises:
a) forming a liquid additive composition comprising a peroxygen component and a neutralization component;
b) contacting the liquid additive composition with a hydrogen sulfide-containing fluid to form a contacted mixture; and
c) separating the contacted mixture to form sulfur-containing materials and at least one of a non-aqueous liquid phase and a gas phase.

Commonly, the hydrogen sulfide content of the hydrogen sulfide-containing fluid comprises hydrogen sulfide and at least one of natural gas, water, brine, petroleum, and mixtures thereof. Typically, the hydrogen sulfide content of the hydrogen sulfide-containing fluid ranges from about 5×10⁻⁴ to about 90 wt % hydrogen sulfide.

In one embodiment, the peroxygen component comprises a peroxygen compound. Preferably, the peroxygen compound is typically selected from the group consisting essentially of peroxides, hydrogen peroxides, persulfates, thiourea dioxides, percarbonates, perborates, diethylhydroxyamines, peracetic acids, and mixtures thereof. More preferably, the peroxygen compound comprises hydrogen peroxides. In another embodiment, the peroxygen component comprises an aqueous solution of the peroxygen compound. In a preferred embodiment, the peroxygen component comprises an aqueous mixture of peroxides. In a more preferred embodiment, the peroxygen component comprises a stabilized peroxide, in an even more preferred embodiment the peroxygen component comprises an alkali-stabilized peroxide. A non-limiting example of an alkali stabilized peroxide is BURCO® PEROXY BASE 2 manufactured by Burlington Chemical Co., LLC. One formulation comprises from about 0.1 to about 95 wt. % peroxygen compound.

The neutralization component typically comprises an aqueous solution of a hydroxide-containing compound. In a preferred embodiment, the hydroxide-containing compound is selected from the group consisting of essentially NaOH, KOH, LiOH, RbOH, CsOH, Mg(OH)₂, Na₂CO₃, K₂CO₃, NaHCO₃, KHCO₃, and mixtures thereof. One formulation comprises from about 0.1 to about 95 wt. % neutralization compound.

In one embodiment, the liquid additive composition comprises typically comprises from about 5 wt % to about 95 wt % of the peroxygen component and from about 95 wt % to about 5 wt % of the neutralization component. In one preferred embodiment, the liquid additive composition comprises from about 6 to about 30 wt % H₂O₂ and from about 5 to about 30 wt % KOH, the remainder consisting essentially of water.

In one embodiment, the liquid additive composition further includes a surfactant. Preferably, the surfactant comprises at least one of a quaternary amine, an alkane sulfonate, a block copolymer alcohol, a propylene oxide and ethylene oxide block copolymer, nonylphenoxypoly(ethyleneoxy) ethanol, and octylphenoxypoly (ethyleneoxy) ethanol. The surfactant may also include a fluorocarbon surfactant.

In one embodiment, the liquid additive composition is formed from an additive composition that comprises at least about 20 wt. % alkalis, at least about 25 wt. % of the peroxygen component, at least about 15 wt. % of a silicate, from about 5 wt. % of a hydrated builder, at least about 0.01 wt. % of a surfactant, and at least about 2 wt. % of a chelate.

Typically, the hydrogen sulfide-containing fluid and the liquid additive composition are contacted within an enclosed vessel to form a contacted mixture. In one embodiment, the contacted mixture comprises the hydrogen sulfide-containing fluid, the peroxygen component, and the neutralization component. In one embodiment, the liquid additive composition is contacted with the hydrogen sulfide-containing fluid by one of misting, spraying, bubbling, sparging, purging, sprinkling, agitating, or combinations thereof. In a preferred embodiment, the liquid additive composition is contacted with the hydrogen sulfide-containing fluid by one of misting and/or spraying the liquid additive composition at or near a portal where the hydrogen sulfide-containing fluid enters the enclosed vessel.

Typically, the ratio of the number of moles the peroxygen compound to the number of moles of hydrogen sulfide in the contacted mixture is from about 0.5 to about 15 and the ratio of the number of moles of the hydroxide-containing compound to the number of moles of hydrogen sulfide in the contacted mixture is from about 0.5 to about 10. In one preferred embodiment, the ratio of the number of moles of the peroxygen compound to the number of hydrogen sulfide in the contacted mixture is from about 2 to about 10 and the ratio of the number of moles the hydroxide-containing compound to hydrogen sulfide is from about 1 to about 5.

In one embodiment, the contacting of the hydrogen sulfide-containing fluid with the liquid additive composition forms a sulfur-containing oxide reaction product. Typically, the sulfur-containing oxide product combines with water contained within the contacted mixture to form a sulfur-containing acid reaction product. While not wishing to be bound by any theory, the sulfur-containing acid product is believed to react with the hydroxide-containing compound of the neutralization component comprising the contacted mixture to form a sulfur-containing acid salt reaction product.

In one embodiment, the sulfur-containing reaction product includes at least about 5 wt. % of hydrocarbons; at least about 0.001 wt. % peroxygen compound; and at least about 5 ppm of hydrosulfuric acid. The product can further include one or more of: a sesquisilicate and/or metasilicate; a surfactant; a chelate; a hydrated builder; and at least about 0.001 wt. % of at least one of a Lewis and/or a Brønsted-Lowry base. The product can further include small amounts of unreacted hydrogen sulfide.

In another embodiment of the present invention, the contacted mixture is separated into a sulfur-containing mixture and at least one of a non-aqueous liquid phase and a gas phase. Typically, the gas phase comprises a natural gas product and the non-aqueous liquid phase comprises a liquid petroleum product. The sulfur-containing mixture comprises substantially most or all of the sulfur-containing reaction products resulting from the reaction of the liquid additive composition with the hydrogen sulfide of the hydrogen sulfide-containing fluid. That is, the sulfur-containing mixture comprises one or more of the sulfur-containing oxide, the sulfur-containing acid, and the sulfur-containing acid salt reaction products.

The liquid additive composition can have a number of advantages. For example, it can convert, at high rates, hydrogen sulfide into environmentally benign products. The composition itself can use components that are environmentally benign. The peroxygen compound can neutralize the hydrogen sulfide in an efficient and environmentally friendly system. The composition can kill the anaerobic bacteria responsible for the production of hydrogen sulfide. This is particularly beneficial in a hydrocarbon producing well.

These and other advantages will be apparent from the disclosure of the invention contained herein.

An “alkali” refers to any compound that has highly basic properties. Alkalis are often hydroxides of alkali metals (metals that belong to Group IA of the periodic table, including lithium (Li), sodium (Na), potassium (K), rubidium (Rb), cesium (Cs), and francium (Fr). Alkalis are strong bases that turn litmus paper from red to blue; they react with acids to yield neutral salts; and they are caustic and in concentrated form are corrosive to organic tissues. The term alkali is also applied to the soluble hydroxides of such alkaline-earth metals as calcium, strontium, and barium and also to ammonium hydroxide.

An “asphaltene” is a component of bitumen.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B or C” and “A, B, and/or C” means A alone, B alone, C alone, A and B together, A and C together, B and C together, or A, B and C together.

“Bitumen” is a mixture of hydrocarbons.

A “builder” is a substance added to soaps or detergents to increase their cleansing action.

A “chelate” is a type of coordination compound in which a central metal ion, such as Co²⁺, Ni²⁺, Cu²⁺, or Zn²⁺, is attached by coordinate links to two or more nonmetal atoms in the same molecule, called ligands. Heterocyclic rings are formed with the central (metal) atom as part of each ring. Ligands offering two groups for attachment to the metal are termed bidentate (two-toothed); three-groups, tridentate; etc. A common chelating agent is ethylene-diaminetetraacetic acid, N-hydroxyethylenediaminetriacetic acid, (poly) alkylphosphonic acid, nitrilotriacetic acid, and ethyleneglycol-bis(β-aminoethyl ether)-N,N-tetraacetic acid.

“Dissolve” refers to the formation of a solution from two or more substances. Typically, the solution is a homogeneous mixture composed of the two or more substances. In such a mixture, a solute is dissolved in another substance, known as a solvent.

A “hydrocarbon” is an organic compound exclusively including elements of carbon and hydrogen. The principal types of hydrocarbons include aliphatic (straight-chain) (which includes paraffins or alkanes, olefins, alkenes, alkalidienes, acetylenes, and acyclic terpenes) and cyclic (closed ring) (which includes alicyclic (cycloparaffins, cycloolefins, and cycloacetylenes), aromatic (which includes the benzene group, naphthalene group, and anthracene group), and cyclic terpenes.

“Kerogen” is an organic compound of oil shale and is normally a mixture of aliphatic and aromatic compounds of humic and algal origin.

“Oil” is applied to a wide range of substances and can be classified by type and function. The primary classification discussed herein is mineral (petroleum (aliphatic or wax-base, aromatic or asphalt-base, and mixed base) and petroleum-derived).

A “paraffin” is a class of aliphatic hydrocarbons characterized by a straight or branched carbon chain.

A “peroxygen compound” is a compound comprising the peroxide ion. The peroxide ion is an oxygen-containing ion in which the two atoms of oxygen are linked by a single bond.

“Solubility” refers to the state or quality of being soluble, capability of being melted or dissolved; amount of a substance that can be dissolved in a solvent.

“Solubilize” refers to making soluble or increasing solubility.

“Soluble” means the degree to which a substance dissolves in a solvent to make a solution (usually expressed as grams of solute per litre of solvent). Solubility of one fluid (liquid or gas) in another may be complete (totally miscible; e.g., methanol and water) or partial (oil and water dissolve only slightly).

A “surfactant”, or surface-active agent, is any compound that reduces surface tension when dissolved in water or water solutions or which reduces interfacial tension between two liquids or between a liquid and solid. There are generally three categories of surface-active agents, namely detergents, wetting agents, and emulsifiers.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWING

FIG. 1 depicts a method of one aspect of the present invention;

FIG. 2 depicts a treatment circuit according to an aspect of the present invention;

FIG. 3 depicts a treatment system according to an aspect of the present invention; and

FIG. 4 depicts a treatment system according to an aspect of the present invention.

### DETAILED DESCRIPTION

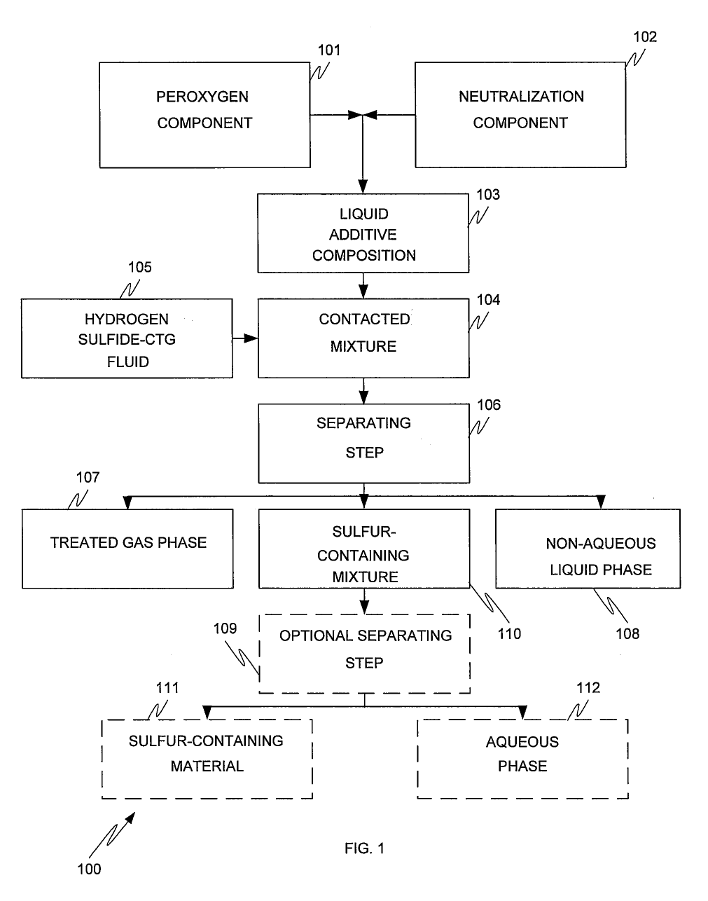

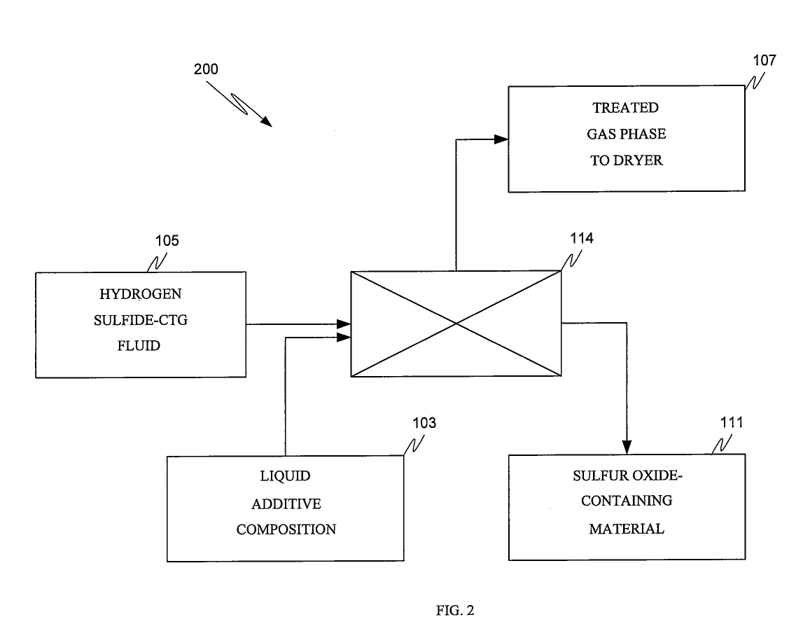

FIG. 1 depicts a method 100 and FIG. 2 a treatment circuit 200 for treating a hydrogen sulfide (H₂S)-containing fluid 105 to produce a sulfur-containing material 111. The method comprises: (a) forming a liquid additive composition 103 comprising a peroxygen component 101 and a neutralization component 102; (b) contacting the liquid additive composition 103, by techniques known to one of ordinary skill in the art, with the hydrogen sulfide-containing fluid 105 to form a contacted mixture 104; and (c) separating (in step 106 and using techniques known to one of ordinary skill in the art) the contacted mixture 104 into a sulfur-containing mixture 110 and at least one of a gas phase 107 and a non-aqueous liquid phase 108. The method 100 can also include an optional separating step 109, where the sulfur-containing mixture 110 is typically separated into an aqueous phase 112 and the sulfur-containing material 111. The separating step 109 can be any suitable technique, including filtration, gravity separation, centrifugation, and the like.

The hydrogen sulfide-containing fluid 105 can be any fluid containing hydrogen sulfide. Typically, the hydrogen sulfide-containing fluid 105 comprises hydrogen sulfide and at least one of a hydrocarbon (such as, natural gas and/or petroleum), water, brine, oil field chemicals, biological mater, inorganic mater, carbon dioxide, nitrogen, and mixtures thereof. Commonly, the hydrogen sulfide-containing fluid 105 is one of a gas, a liquid, or a mixture thereof. More commonly, the hydrogen sulfide-containing fluid 105 is one of a petroleum processing stream, a gas processing stream or a combination thereof resulting from a well-head production treatment process. Non-limiting examples of suitable well-head production treatment processes are heater treaters, electrostatic treaters, and/or de-emulsification treaters. Even more commonly, the hydrogen sulfide-containing fluid 105 is the gas processing stream resulting from a de-emulsification process.

In one application, the hydrogen sulfide-containing fluid comprises at least about 5 wt. % hydrocarbons, such as one or more of oil, bitumen, kerogen, asphaltenes, and paraffins.

In one application, the hydrogen sulfide-containing fluid includes a gas that includes typically from about 5 to about 25,000 ppm/ft³, more typically from about 10 to about 10,000 ppm/ft³, and even more typically from about 20 to about 5,000 ppm/ft³ hydrogen sulfide; typically from about 0 to about 5 mole % carbon dioxide (CO₂); typically from about 5 to about 75 mole % and even more typically from about 10 to about 65 mole % methane (CH₄); typically from about 0.5 to about 25 mole % and even more typically from about 2 to about 5 mole % ethane (C₂H₆); typically from about 2.5 to about 15 mole % and even more typically from about 5 to about 10 mole % propane (C₃H₈); typically from about 0.5 to about 7.5 mole % and even more typically from about 0.5 to about 5 mole % iso-butane ((CH₃)₂CHCH₃); typically from about 0.5 to about 7.5 mole % and even more typically from about 0.5 to about 5 mole % n-butane (CH₃CH₂CH₂CH₃); typically from about 0.5 to about 7.5 mole % and even more typically from about 0.5 to about 5 mole % iso-pentane ((CH₃)₂CH CH₂CH₃); typically from about 0.5 to about 7.5 mole % and even more typically from about 0.5 to about 5 mole % n-pentane (CH₃(CH₂)₃CH₃); typically from about 0.5 to about 7.5 mole % and even more typically from about 0.5 to about 5 mole % iso- and n-hexanes; and typically from about 0.5 to about 7.5 mole % and even more typically from about 0.5 to about 5 mole % hydrocarbons heavier than hexanes. The fluid may contain liquid hydrocarbons and water. The fluid may be predominantly gas or liquid, depending on the application.

In a first formulation, the liquid additive includes peroxygen and neutralization components 101 and 102.

The peroxygen component 101 comprises a peroxygen compound, such as, but not limited to peroxides, hydrogen peroxides, persulfates, thiourea dioxides, percarbonates, perborates, diethylhydroxylamines, peracetic acids, superoxides, and mixtures thereof. The peroxygen compound is typically a liquid or a solid. The peroxygen compound can be organic or inorganic. Organic peroxides commonly contain a —O—O— linkage, where one oxygen atom (that is, O) is covalently bonded to an organic radial (that is, R) and the other oxygen atom is typically covalently bonded to another organic radial (that is, R′) or a hydrogen atom (that is, H). The organic radicals, R and R′ can be the same or differ. Inorganic peroxides typically contain the O₂²⁻ anion, while superoxides typically contain the O₂¹⁻ anion. In one embodiment, the preferred peroxygen component 101 comprises an aqueous solution of the peroxygen compound preferably ranging in concentration from about 0.05 to about 99 wt. %, more preferably from about 1 to about 99 wt % of the peroxygen compound, and even more preferably from about 5 to about 50 wt % of the peroxygen compound. In one embodiment, inorganic peroxides are preferred. Non-limiting examples of suitable inorganic peroxides are hydrogen peroxides and alkali metal peroxides. In a more preferred embodiment, the peroxygen component 101 comprises an aqueous solution of hydrogen peroxide having a concentration from about 20 to about 40 wt % H₂O₂. In an even more preferred embodiment, the peroxygen component 101 comprises an aqueous solution of an alkali stabilized hydrogen peroxide having a concentration from about 20 to about 40 wt % H₂O₂.

The neutralization component 102 commonly comprises a Lewis and/or a Brønsted-Lowry base. In a preferred embodiment, the neutralization component 102 typically comprises a hydroxide-containing and/or hydroxide-producing compound. Typical, non-limiting examples of preferred hydroxide-containing compounds are NaOH, KOH, LiOH, RbOH, CsOH, Mg(OH)₂, Na₂CO₃, NaHCO₃, K₂CO₃, KHCO₃ and mixtures thereof. The neutralization component 102 typically comprises a liquid mixture. Preferably, the liquid mixture comprises an aqueous mixture. In one preferred embodiment, the neutralization component 102 comprises an aqueous KOH solution having from about 5 to about 60 wt % KOH, even more preferred the neutralization component 102 comprises from about 20 to about 40 wt % KOH. While not wanting to be bound by any theory, KOH or K₂CO₃ is typically preferred for its solubility properties throughout the treatment process 100. In one configuration, the neutralization component 102 is formed using electrolysis techniques, such as a chloralkali process. The choralkali process commonly uses a pressure vessel that has been fitted with a series of fritted filtering stones in the bottom of the vessel approximately one foot off of the bottom. The gas entering this closed system can be regulated to control the pressure and the flow of the gas. Once the gas is passed through the stones, very tiny bubbles are formed, with the rate of the assent being determined by the pressure and flow rate of the gas. By adjusting these two variables, a complete reaction in the vessel is realized.

In one application, the hydrogen sulfide-containing fluid includes various sulfur compounds in addition to hydrogen sulfide, such as sulfates, and the first formulation is believed to react with typically at least most, more typically at least about 65% and even more typically at least about 75% of the sulfur components of the hydrogen sulfide-containing fluid according to one or more of the following equations:

H₂S+H₂O₂→S+2H₂O

S²⁻+4H₂O₂→SO₄²⁻+4H₂O

S₂−+H₂O₂→O₂S+H₂(gas)→O₂S+H₂O→SO₃²⁻+H₂(gas)

SO₃²⁻+H₂O₂→SO₄²⁻+H₂O

SO₃²⁻+H₂(gas)→H₂SO₃

SO₄²⁻+H₂(gas)→H₂SO₄

HSO₃+H₂O₂→HSO₄+H₂O

Once the oxidation and/or formation of sulfuric acid have been substantially completed, the simple acid/base reaction is believed to occur by which preferably at least most and more preferably at least about 75% of the hydrogen sulfide is converted into a sulfur-containing material other than hydrogen sulfide. Exemplary reactions are believed to include:

H₂SO₄+K₂CO₃→K₂SO₄→H₂O+CO₂(gas)

H₂SO₄+2KOH→K₂SO₄+2H₂O

The liquid additive composition 103 is typically formed by mixing, with water, an additive composition comprising the peroxygen component 101 and neutralization component 102. The peroxygen component 101 and neutralization component 102 of the additive composition can be mixed and/or combined by methods commonly known to those of skill in the art. Non-limiting examples of such mixing methods are solution and/or solid phase mixing methods, such as, mixing by paddles, impellers, flow, and/or tumble. It can be appreciated that, the addition rate and/or order of mixing typically depends on the chemistry and stoichiometry of the peroxygen component 101 and neutralization component 102.

The additive composition 103 typically comprises from about 5 to about 95 wt % of the peroxygen component 101 and from about 95 to about 5 wt % of the neutralization component 102, preferably the additive composition 103 comprises from about 5 to about 50 wt % of the peroxygen compound and from about 15 to about 75 wt % of the neutralization component, the remainder comprising a carrier liquid, such as water. In one preferred embodiment, the additive composition 103 comprises from about 6 to about 40 wt % H₂O₂ and from about 5 to about 40 wt % KOH or K₂CO₃, the remainder consisting essentially of water. In an even more preferred embodiment, the additive composition 103 comprises from about 10 to about 25 wt % H₂O₂ and from about 5 to about 20 wt % KOH or K₂CO₃, the remainder consisting essentially of water.

The first formulation can also include other components. For example, the formulation can include one or more surfactants, such as quaternary amine surfactant. It is preferred that foaming be inhibited by adding a defoamer and/or alkali metal hydroxide.

In one example, the additive composition 103 is typically formed by solution mixing about 60 parts of an aqueous peroxygen component 101 comprising about 30 wt % hydrogen peroxide with about 40 parts of an aqueous neutralization component 102 comprising about 30 wt % potassium hydroxide.

In forming the liquid additive composition, the additive composition is typically diluted in a ratio ranging from about 1 pound additive composition:0.5 gals. water to about 1 pound additive composition:10 gals. water and even more typically from about 1 pound additive composition:0.75 gals. water to about 1 pound additive composition:5 gals. water.

In a second formulation, the liquid additive composition 103 includes the peroxygen and neutralization components 101 and 102 and other constituents and is formed from a granular additive composition.

The additive composition, when dissolved in a solvent such as water, has certain properties for enhanced results. Preferably, the composition is nonionic when dissolved in water. Preferably, the oxidation potential of the additive composition is at most about −100 mV versus a standard hydrogen electrode (SHE), preferably at most about −200 mV versus SHE, and more preferably at most about −250 mV versus SHE. Preferably, the surface tension of the additive composition is at most about 28 dynes, preferably at most about 24 dynes, and more preferably at most about 22 dynes. Preferably, the additive composition has a sufficient amount of surfactants and alkalis to maintain paraffins and asphaltenes in suspension. In one particular formulation, the additive composition preferably comprises at least about 20 wt. % alkalis, even more preferably at least about 30 wt. %, and even more preferably from about 30 to about 40 wt. % alkalis and has a pH of at least about pH 11 and even more preferably ranging from about pH 12.5 to about pH 13. The additive composition commonly has an Na₂O meq value of preferably at least about 20 meq at a pH of about pH 8, more preferably about at least 25 meq, and even more preferably a Na₂O meq value of least about 30 meq at a pH of about pH 8. In one exemplary formulation, the additive composition has a Na₂O meq value at a pH of about pH 4 preferably of at least about 25 meq, more preferably about at least 35 meq, and even more preferably a Na₂O meq value at a pH of about pH 4 of least about 40 meq.

In one embodiment, the additive composition is the composition described in U.S. Pat. No. 6,043,207, with an issue date of Mar. 28, 2000, entitled “Non-Caustic Additive Comprising Peroxygen Compound, Meta/Sesqui-Silicate, Chelate and Method of Making the Same in Free-Flowing, Particulate Form” and U.S. Pat. No. 6,194,367, with an issue date of Feb. 27, 2001, entitled “Non-Caustic Additive Comprising Peroxygen Compound and Specific Silicate and Method of Making the Same in Free-Flowing Particulate Form” both to Talley, each of which is incorporated fully herein by this reference in their entirety. In these patents, Talley teaches an alkaline additive for removing protein, grease, and other organic deposit and stains from articles such as those used in the food industry.

In this formulation, the additive composition preferably includes (a) the peroxygen compound, (b) a silicate, (c) a builder, (d) a surfactant, and (e) a chelate. The silicate and builder act as the neutralization component 102. Preferably, the additive composition is substantially free of chlorine-containing compounds and hydroxides. In a preferred embodiment, the silicate is a metasilicate and/or sesquisilicate. The composition is preferably substantially free of a gelling agent. The additive composition is typically in a dry, granulated form which is dissolved in a carrier, such as water, to form a liquid additive composition before use.

While not wishing to be bound by any theory, it is believed that the peroxygen compound releases the peroxide ion that not only kills microbes (anaerobic bacteria and other microbes are typically found to be present with hydrogen sulfide) but also reacts with H₂S to form sulfates and/or sulfuric acid, which is neutralized by the neutralization component 102. In addition to acting as a neutralization component, the silicate is believed to carry the charge and maintain the surfactant in the aqueous solution. In addition to acting as a neutralization component, the builder is believed to provide sufficient alkalinity to peptize, emulsify, and/or saponify paraffins, asphaltenes, and other hydrocarbons. The chelate is believed to dissolve alkaline earth metals, particularly Ca²⁺, in surrounding deposits and tie up dissolved metals, which would otherwise react with and neutralize the peroxide ion. The surface-active agent, or surfactant, is believed to provide enhanced penetration into the rock pores and fractures and cleave hydrocarbons.

The peroxygen compound preferably includes any of the compounds noted above in connection with the first formulation, even more preferably a perborate and/or percarbonate and even more preferably a percarbonate. The peroxygen compound can be complexed with a metal, preferably an alkali or alkaline earth metal selected from the group including sodium, lithium, calcium, potassium, and boron. The additive composition preferably includes at least about 25% by weight, more preferably from about 25% to about 40% by weight, and even more preferably from about 25% to about 35% by weight of the peroxygen compound.

The silicate is preferably a metasilicate and/or sesquisilicate. The silicate is believed to react with sulfuric acid according to the following equation:

H₂SO₄+Na₄SiO₄→Na₂SO₄+Na₂SiO₂+H₂(gas)

The silicate is preferably in the anhydrous form and is normally compounded with an alkali or alkaline earth metal. The alkali metal is preferably one or more of sodium and potassium. The additive composition preferably includes at least about 15% by weight, more preferably from about 20% to about 40% by weight, and most preferably from about 25% to about 35% by weight of the silicate.

The builder can be any suitable builder. Preferably, the builder is one or more of a sulfate, carbonate, phosphate, and sesquicarbonate. The sulfate is, for example, an alkali or alkaline earth metal sulfate, with sodium sulfate being preferred. The phosphate is preferably a tripolyphosphate, trisodium polyphosphate, sodium potassium pyrophosphate, sodium hexametaphosphate, disodium phosphate, and/or monosodium phosphate. The carbonate is preferably one or more of an alkali or alkaline earth metal carbonate, sesquicarbonate, bicarbonate. When the builder is sodium carbonate, it is believed to neutralize sulfuric acid according to the following equation:

H₂SO₄+Na₂CO₃→Na₂SO₄+H₂O+CO₂(gas)

When the additive composition includes a surfactant, the carbonate and phosphate are preferably in the hydrated form, such as trona or soda ash. In one formulation, the builder comprises a phosphate in an amount ranging from about 5 to about 15 wt. % and even more preferably from about 7.5 to about 12.5 wt. %.

While not wishing to be bound by any theory, it is believed that the hydrated builders, such as the hydrated phosphates and/or carbonates, form bonds with the surfactants which are hydrophilic substances, thereby immobilizing the surfactant and water. As will be appreciated, the surfactant and water will react with the peroxygen compound unless the surfactant and water are immobilized. The reaction reduces and therefore neutralizes the peroxygen compound while causing the release of oxygen gas. The reaction not only adversely impacts the shelf life and hydrogen sulfide removal efficiency of the additive composition but also can cause a hazardous pressure build up from the released oxygen gas. The use of adequate amounts of hydrated builders has been found to substantially eliminate these problems.

The amount of hydrated builder in the additive composition normally depends upon the amount of surfactant in the additive composition. Preferably, the molar ratio of the hydrated builder to the surfactant is at least about 4 parts of hydrated builder to one part surfactant, more preferably ranges from about 6 to about 22 parts of hydrated builder to one part surfactant, and even more preferably ranges from about 8 to about 10 parts of hydrated builder to one part surfactant. The total amount of builder in the additive composition (both in the hydrated and anhydrous forms) varies depending upon the application. The additive composition preferably includes at least about 20 wt. % by weight, more preferably from about 20% to about 75% by weight, and even more preferably from about 25% to about 50% by weight of the builder.

It has been discovered that phosphate builders have several beneficial effects on the performance of the additive composition in addition to immobilizing the surfactant in water. The phosphate helps the chelate tie up free metals. In sufficient amounts of the phosphates, dry blending of the additive composition is much less difficult. Preferably, the additive composition contains from about 3% to about 15% by weight phosphates.

The additive composition can further include a surfactant. The surfactant should be functional in an alkaline solution. Suitable surfactants are nonionic, anionic and amphoteric surfactants.

Preferred nonionic surfactants include octylphenoxy-polyethoxy-ethanol (e.g., sold under the trademark TRITON X-100), nonyl phenoxy ethyleneoxy ethanol (e.g., sold under the trademark IGEPAL CO730), nonylphenoxypoly(ethyleneoxy) ethanol (e.g., sold under the trademark IGEPAL CO630), octylphenoxypoly(ethyleneoxy) ethanol (e.g., sold under the trademark IGEPAL 630), polyoxy ethoxylated ethanol (e.g., sold under the trademark RENEX ZO), glycol fatty esters (e.g., sold under the trademark HALLCO-376-N), fatty acid alkylanolamid (e.g, sold under the trademark ALKAMIDE 2110), cetyldimethyl amine oxide (e.g., sold under the trademark AMMONYX CO), aliphatic polyether (e.g., sold under the trademark ANTAROX LF-344), polyethylenated alkyl glycol amide (e.g., sold under the trademark ANTAROX G-200), fatty alcohol polyether (e.g., sold under the trademark AROSURE 63-PE-16), polyoxyethylene sorbitol esters of mixed fatty and resin acids (e.g., sold under the trademark ATLAS G-1234), modified oxyethylated straight-chain alcohol (e.g., sold under the trademark RENEX 648), modified oxyethoxylated straight-chain alcohols (e.g. sold under the trademark PLURAFAC RA, ZO), PO/EO block copolymer alcohols of propylene oxide (PO)/ethylene oxide (EO) (e.g., sold under the tradename PLURONIC® 25-R-2), alkylaryl polyether (e.g., sold under the trademark TRITON CF10), trifunctional polyoxyalkylene glycols (e.g., sold under the trademark PLURADOT HA-410), diethylene glycol dioleate, polyethylene glycol recinaleate, polyethylene glycol dioleate, tridecyl alcohol, nonylphenol, and ethylene oxide condensation products that are based on propylene oxide-propylene glycol (e.g., sold under the trademark PLURONIC L-61), ethoxylated alkylphenols (e.g., sold under the trademarks IGEPAL RC-620, ALKASURF OP-12, and TRITON N-101), propoxylated and ethoxylated fatty acids, alcohols, or alkylphenols (e.g., sold under the trademarks TRITON XL-80N and ANTAROX BL-330), ethoxylated alcohols (e.g., sold under the trademarks PLURAFAC A, TRITON CF-54, TERGITOL TMN-6, and TERGITOL 15-5-7), alkoxylated linear aliphatic alcohol (e.g., sold under the trademark OLIN SL-42), and alcohol alkoxylate (e.g., sold under the trademark SURFONIC LF-17). Preferred anionic surfactants include ethoxylated (3 moles) phosphate ester (e.g., sold under the trademark TRITON QS-44), sodium sulfate of 2 ethyl-a-hexanol (e.g., sold under the trademark TERGITOL 08), sodium petroleum sulfonate (e.g., sold under the trademark PETRONATE K), sodium alkyl naphthalene sulfonate (e.g., sold under the trademark PETRO AR, SELLOGEN K, NEKAL BX-78, ALKANOL B), primary alkane sulfonate (e.g., sold under the trademark BIO TERG PAS-8S), dioctyl ester of sodium sulfosuccinic acid (e.g., sold under the trademark ABRESOL OT), sodium alkylaryl sulfonate (e.g., sold under the trademark AHCOWET ANS), sodium salt of sulfated alkylphenoxy poly(ethyleneoxy) ethanol (e.g., sold under the trademark ALIPAL EO-526), sodium methyl n-oleyl-taurate (e.g., sold under the trademark AMATER G T), alkyl polyphosphate (e.g., sold under the trademark ATCOWET C2), sodium lauryl sulfate (e.g., sold under the trademark AVIROL 101), sodium N-methyl-N-tall oil acid taurate (e.g., sold under the trademark IGEPON TK-32), lauric alkyloamine condensate (e.g., sold under the trademark NOPCOGEN 14-L), fatty alcohol sulfate modified (e.g. sold under the trademark RICHOLOL 4940), modified diethanolamides of fatty acids (e.g., sold under the trademark SHERCOMID), sulfates of alcohols (e.g., sold under the trademark STANDOPAL LF), sulfonates of naphthalene and alkyl naphthalene (e.g., sold under the trademark PETRO WP) and alkanolamides (e.g., sold under the trademark NOPCO 1179). Preferred amphoteric surfactants include disodium N-tallow betamino dipropionate (e.g., sold under the trademark DERIPHATE 154), sodium derivative of dicarboxylic caprylic acid (e.g., sold under the trademark MIRANOL J2M, letithin (e.g., sold under the trademark CENTROL CA, LA), lauryl ampholytic (syndet) (e.g., sold under the trademark SCHERCOTERIC BASE 156), carboxylic acid derivatives of substituted imidazolines (e.g., sold under the trademark MONATERIC), complex coco betaine (e.g., sold under the trademark CARSONAM 3 AND 3147), fatty sulfobetaine (e.g., sold under the trademark LONZAINE CS), dicarboxylic coconut derivative triethanolamine (e.g., sold under the trademark MIRANOL TEA), dicarboxylic octoic derivative sodium salt (e.g. sold under the trademark MIRANOL JEM), dicarboxylic myristic derivative diethanolamine (e.g., sold under the trademark MIRANOL M2M-DEM), dicarboxylic myristic derivative monoethanolamine (e.g., sold under the trademark MIRANOL M2M-MEA), dicarboxylic myristic derivative sodium salt (e.g., sold under the trademark MIRANOL M2M-SF), dicarboxylic capric derivative diethanolamine (e.g., sold under the trademark MIRANOL S2M-DEA), imidazolnes and imidazline derivatives (e.g., sold under the trademark MONATERIC 949-J), dicarboxylic capric derivative triethanolamine (e.g., sold under the trademark MIRANOL S2M-TEA), and other amphoteric surfactants (e.g., sold under the trademark PHOSPHOTERIC T-C6).

Even more preferred surfactants include (i) the nonionic surfactants, nonylphenoxypoly(ethyleneoxy) ethanol (e.g., sold under the trademark IGEPAL CO630), octylphenoxypoly (ethyleneoxy) ethanol (e.g., sold under the trademark IGEPAL 630), ethoxylated alkylphenols (e.g., sold under the trademarks IGEPAL RC-620, ALKASURF OP-12, and TRITON N-101), propoxylated and ethoxylated fatty acids, alcohols, or alkylphenols (e.g., sold under the trademarks TRITON XL-80N and ANTAROX BL-330), ethoxylated alcohols (e.g., sold under the trademarks PLURAFAC A, TRITON CF-54, TERGITOL TMN-6, and TERGITOL 15-5-7), alkoxylated linear aliphatic alcohol (e.g., sold under the trademark OLIN SL-42), diethylene glycol dioleate, polyethylene glycol recinaleate, polyethylene glycol dioleate, tridecyl alcohol, nonylphenol, and ethylene oxide condensation products that are based on propylene oxide-propylene glycol (e.g., sold under the trademark PLURONIC L-61), block copolymer alcohols (e.g., sold under the tradename PLURONIC® 25-R-2), and alcohol alkoxylate (e.g., sold under the trademark SURFONIC LF-17); (ii) the anionic surfactants, primary alkane sulfonate (e.g., sold under the trademark BIO TERG PAS-8S), sulfates of alcohols (e.g., sold under the trademark STANDOPAL LF), sulfonates of naphthalene and alkyl naphthalene (e.g., sold under the trademark PETRO WP), and alkanolamides (e.g., sold under the trademark NOPCO 1179); and (iii) the amphoteric surfactants, imidazolnes and imidazline derivatives (e.g., sold under the trademark MONATERIC 949-J), and the amphoteric surfactant sold under the trademark PHOSPHOTERIC T-C6.

Even more preferred surfactants include the low foaming surfactants, primary alkane sulfonate sold under the trademark BIO TERG PAS-8S, block copolymer alcohols (e.g., sold under the tradename PLURONIC® 25-R-2), and propylene oxide and ethylene oxide block polymer sold under the trademark PLURONIC L-61 and the high foaming surfactants, nonylphenoxypoly (ethyleneoxy) ethanol sold under the trademark IGEPAL CO 630 and octylphenoxypoly (ethyleneoxy) ethanol sold under the trademark IGEPAL CA 630.

In one particular formulation, the additive composition comprises one or more low HLB surfactants and one or more high HLB surfactants. In one formulation, the low HLB surfactant is a surfactant having an HLB value less than about 12, preferably less than about 10, and more preferably less than about 8. Non-limiting examples of the low HLB surfactants are BioTerg® PAS-85, having an HLB value of about 12, and Pluronic® 25-R-2, having an HLB of about 4. In another formulation, the high HLB surfactant is a surfactant having an HLB value greater than about 8, preferably greater than about 10, and more preferably greater than about 12. Non-limiting examples of the high HLB surfactants are Pluronic® L-61, having an HLB value of about 16, and Tomadol® 91-6, having an HLB value of about 12.5.

In one particular formulation, the additive composition includes preferably from about 0.01 to about 1.0 wt. % and even more preferably from about 0.05 to about 0.5 wt. % of a fluorocarbon surfactant sold by DuPont under the tradename Capstone FS-51 to impart heat and pressure resistance to the composition. The fluorocarbon surfactant has an HLB value of about 18 and has been found to provide enhanced recovery of kerogen from oil shale and hydrocarbon recovery from deeper hydrocarbon-containing formations. While not wishing to be bound by any theory, the surfactant is believed to facilitate and accelerate hydration of the silicate and percarbonate by lowering the surface tension.

The amount of the surfactant in the additive composition can be important to the effectiveness of the additive composition. Preferably, the additive composition contains at least about 2.5% by weight and more preferably from about 2.5% to about 10% by weight, and most preferably from about 2.5% to about 8% by weight of the surfactant.

The chelate can be any suitable chelate. Preferably, the chelate is a derivative of a carboxylic, phosphoric, or phosphonic acid. More preferably, the chelate is selected from the group consisting of EDTA, NTA, and other derivatives of a carboxylic acid, phosphoric acid, and phosphonic acid, such as poly(alkylphosphonic acid) (e.g., sold under the trademark ACUSOL 505ND) and tripolyphosphates. The EDTA acid is preferably in the form of an alkali or alkaline earth metal salt, such as a sodium salt (“ETDA-Na₄”) or a potassium salt, as the salt is more water soluble than the acid. The additive composition preferably includes at least about 2% by weight, more preferably an amount ranging from about 2% to about 8% by weight, and even more preferably an amount ranging from about 4% to about 6% by weight of the chelate, with the optimum amount being about 5% by weight.

In one particular formulation, the peroxygen compound, silicate, and chelate are salts having the same cation. More preferably, all of the salts in the additive composition have the same cation. The preferred cation is an alkali metal, such as sodium or potassium.

The ratios of the various components can be important parameters in many applications. Preferably, the weight ratio of the peroxygen compound to the chelate ranges from about 3:1 to 7:1 and more preferably is about 6:1. The preferred weight ratio of the metasilicate and sesquisilicate on the one hand to the surfactant on the other preferably ranges from about 5:1 to about 15:1 and most preferably is about 9:1. The preferred weight ratio of the metasilicate and sesquisilicate on the one hand to the peroxygen compound on the other preferably ranges from about 1:1 to about 2:1 and is more preferably about 1:1. The preferred weight ratio of the metasilicate and sesquisilicate on the one hand to the chelate on the other preferably ranges from about 5:1 to about 15:1 and most preferably is about 6:1.

The above-noted components of the additive composition are combined by suitable techniques for forming granulated cleaners. For example, the various components are added to a vessel as follows: (i) the various builders are added first, preferably in an anhydrous form, and blended together, (ii) the surfactant is added second and blended with the builders, (iii) water is added after or simultaneously with the surfactants and blended with the surfactants and builders for a sufficient period of time for substantially all of the water to form hydrates with the builder(s), (iv) the silicate, chelate, and peroxygen compound are added in that order, and (v) the gelling agent, if used, is added last. The various components can be blended with any suitable device. In the preceding steps, the peroxygen compound is preferably maintained separate from water and the surfactant as the peroxygen compound will react with water and/or the surfactant, thereby releasing oxygen and neutralizing the peroxygen compound. Thus, the surfactant is preferably added to the vessel before the peroxygen compound.

The addition of water in the third step is preferably carefully controlled. If too much water is added, the resulting additive composition will not be a free flowing particulate, as desired, but will be a highly viscous mass. If too little water is added, the surfactant may not be immobilized and can react with the peroxygen compound. Preferably, the minimum amount of water added is the stoichiometric amount that is sufficient to form hydrates with substantially all of the hydratable builders and the maximum amount of water added is no more than about 150% and more preferably no more than about 125% of the stoichiometric amount. By way of example, if sodium carbonate (Na₂CO₃) is the hydratable builder the molar ratio of sodium carbonate to water preferably ranges from about 50:1 to about 175:1 and most preferably from about 100:1 to about 150:1. In most applications, the molar ratio of hydratable builders to water also ranges from about 50:1 to about 175:1 and more preferably from about 100:1 to about 150:1, and the total amount of water added to the additive composition in the third step and total amount of water in the additive composition, whether occurring as free or hydrated molecules, ranges from about 0.1 to about 0.5% by weight of the final additive composition, with 0.1% by weight being most preferred. The free moisture content of the additive composition is preferably no more than about 0.1% by weight of the additive composition.

The blending time of the third step is preferably carefully controlled to substantially minimize the amount of free water molecules present in the additive composition. The water/surfactant/builder blend is preferably blended for a sufficient period of time for the water to react with substantially all of the hydratable builders and for substantially all of the surfactant to form bonds with the hydrated builders. Preferably, the blending in the third step has a duration of at least about 5 minutes after water addition and more preferably ranging from about 5 to about 10 minutes.

As noted above, the additive composition is preferably a dry, granular material. Before use, the additive composition can be dissolved in water, or other suitable carrier, to form a liquid additive composition. To ensure that the additive composition dissolves rapidly in cold or lukewarm water, the particle sizes of the various ingredients are that of a light density material. Light density materials have a large surface area allowing quicker solubility in cold or lukewarm water. Preferably, the additive composition has a mean particle size ranging from about 20 to about 100 mesh (Tyler), more preferably from about 30 to about 60 mesh (Tyler), and most preferably from about 30 to about 50 mesh (Tyler). The preferred concentration of the additive composition in the additive solution is discussed below. The liquid additive composition preferably has pH ranging from about pH 9 to about pH 13 and more preferably from about pH 11 to about pH 12.

The concentration of the additive composition in the additive solution depends upon the amount of hydrogen sulfide to be removed, the application technique, and the amount of solution required for heat control and to maintain solubility of the sulfur-containing material. As will be appreciated, the acid-base reaction can be highly exothermic. For heat control and solubility, it is preferred that the solution be maintained in the range of about 70% by weight or more of the liquid additive composition. In most applications, the preferred aqueous concentration of the additive composition in the additive solution ranges from about 0.1 to about 8 and even more preferably from about 0.25 to about 5 percent by weight.

After blending with water or another solvent, the liquid additive composition of one formulation commonly comprises at least about 0.1 wt. % and even more commonly from about 0.15 to about 0.8 wt. % of the peroxygen compound, commonly at least about 0.2 wt. % and even more commonly from about 0.3 to about 0.8 wt. % of the silicate, commonly at least about 0.01 wt. % and even more commonly from about 0.05 to about 0.08 wt. % of the builder, commonly at least about 0.002 wt. % and even more commonly from about 0.005 to about 0.008 wt. % of the surfactant, and commonly at least about 0.001 wt. % and even more commonly from about 0.001 to about 0.08 wt. % of the chelate.

Although an additive composition can be formulated in a manner of U.S. Pat. No. 6,043,207 and/or 6,194,367, the present invention is not limited to the composition of matter and/or the method of preparation taught therein.

While specific concentrations of the peroxygen and neutralization components 101 and 102 are provided above, it can be appreciated that, ratios and/or concentrations of the peroxygen component 101 and neutralization component 102 typically vary depending on the concentration of hydrogen sulfide in the hydrogen sulfide-containing fluid 105 being treated and/or rate that the hydrogen sulfide-containing fluid 105 is being contacted with the liquid additive composition 103. While not wanting to be bound by any theory, the concentrations of the peroxygen component 101 and neutralization component 102 in the liquid additive composition 103 are typically determined for optimal removal of the hydrogen sulfide from the hydrogen sulfide-containing fluid 105 and/or formation of the sulfur-containing mixture 110 using the equations noted above. Typically, the ratio of the number of moles the peroxygen compound to the number of moles of hydrogen sulfide in the contacted mixture is from about 0.5 to about 15 and the ratio of the number of moles of the hydroxide-containing compound to the number of moles of hydrogen sulfide in the contacted mixture is from about 0.5 to about 10. In one preferred embodiment, the ratio of the number of moles of the peroxygen compound to the number of hydrogen sulfide in the contacted mixture is from about 2 to about 10 and the ratio of the number of moles the hydroxide-containing compound to hydrogen sulfide is from about 1 to about 5.

It can be further appreciated that the stoichiometry of the liquid additive composition 103 is typically determined to provide optimum stability of the liquid additive composition 103. Preferably, the liquid additive composition 103 is sufficiently stable for at least 5 years. In one embodiment, the liquid additive composition 103 is blended and utilized within a year. In another embodiment, the liquid additive composition 103 is blended and utilized within a month. In yet another embodiment, the liquid additive composition 103 is blended and utilized in less than an hour. The liquid additive composition 103 is typically blended off-site and shipped to the site or blended on-site.

Returning to FIGS. 1-2, the hydrogen sulfide-containing fluid 105 is contacted with the liquid additive composition 103 to form a contacted mixture 104. Typically, the hydrogen sulfide-containing fluid 105 and the liquid additive composition 103 are contacted within an enclosed vessel 114. Typically, the enclosed vessel is a phase separation vessel or scrubber. More preferably, the enclosed vessel 114 is a three-phase, gas, oil, water separation vessel. In one embodiment, the liquid additive composition 103 is contacted with the hydrogen sulfide-containing fluid 105 by one of misting, spraying, bubbling, sparging, purging, sprinkling, agitating, or combinations thereof. In another embodiment, the liquid additive composition 103 is contacted with the hydrogen sulfide-containing fluid 105 as the hydrogen sulfide-containing fluid 105 enters the enclosed vessel 114. In a more preferred embodiment, the liquid additive composition 103 is contacted with the hydrogen sulfide-containing fluid 105 by one of misting and/or spraying the liquid additive composition 103 at or near a portal 113 where the hydrogen sulfide-containing fluid 105 enters the enclosed vessel 114. In an optional embodiment, the peroxygen component 101 and the neutralization component 102 are separately and simultaneously contacted with the hydrogen sulfide-containing fluid 105 within the enclosed vessel 114.

While not wanting to be bound by any theory, the contacting of the peroxygen component 101 and the hydrogen sulfide-containing fluid 105 forms a sulfur-containing oxide reaction product or sulfur oxide-containing material 111, which is typically in the form of a sludge. Non-limiting examples of the sulfur-containing oxides are SₓO_{y}, where x is typically 1, 2, 3, 4, 5, 6, or 7 and y is commonly 1, 2, 3, or 4. Preferably, the sulfur-containing oxide product is typically one of sulfur monoxide, sulfur dioxide, sulfur trioxide, or mixtures thereof. The rate of the sulfur-containing oxide formation typically depends on the contacting time, the contacting temperature, the concentration of hydrogen sulfide in the hydrogen sulfide-containing fluid 105, and the rate of contacting the hydrogen sulfide-containing fluid 105 with the liquid additive composition 103.

As noted above, the sulfur-containing oxide product formed, by the contacting of the peroxygen component 101 with the hydrogen sulfide-containing liquid 105, typically reacts and/or combines with the water comprising the contacted mixture 104 to form a sulfur-containing acid reaction product. The sulfur-containing acid reaction product typically comprises, but is not limited to, one of sulfurous and/or sulfuric acids. Correspondingly, the resulting sulfur-containing acid product commonly reacts with the hydroxide-containing compound comprising the contact mixture 104 to form a sulfur-containing acid salt reaction product. A non-limiting example of a typically preferred sulfur-containing acid salt reaction product is potassium sulfate, K₂SO₄. The potassium sulfate is formed by the reaction of KOH (the preferred hydroxide-containing compound of the neutralization component 102) with H₂SO₄ (formed by the reaction of the preferred peroxygen compound H₂O₂ with H₂S and H₂O). The sulfur-containing acid salt, K₂SO₄, is a relatively benign salt routinely utilized as an active component within agriculture fertilizers.

While not wanting to be bound by any theory, the concentrations of the peroxygen compound in the peroxygen component 101 and the concentration of the hydroxide-containing compound in the neutralization compound 102 comprising the liquid additive composition 103 are commonly formulated to control one or more of the heat of reaction and rate of reaction of the liquid additive composition 103 with the hydrogen sulfide-containing fluid 105. It can be appreciated that, the water contained within the liquid additive composition 103 typically functions as a heat sink for the heat generated in one or more of the chemical reactions of the liquid additive composition 103 with the hydrogen sulfide-containing fluid 105. The liquid additive composition 103 is commonly formulated to control the rate of oxygen generation during formulation and/or contacting with the hydrogen sulfide-containing fluid 105.

It can be appreciated that the concentration of the peroxygen compound in the peroxygen component 101 within the liquid additive composition 103 is typically varied depending on the desired contact time, the contacting temperature within the enclosed vessel, the concentration of the hydrogen sulfide within the hydrogen sulfide-containing fluid 105, and the rate of addition of the hydrogen sulfide-containing fluid 105 to the enclosed vessel.

Typically, the concentration of hydrogen sulfide in hydrogen sulfide-containing fluid 105 is from about 5×10⁻⁴ wt % hydrogen sulfide to about 90 wt % hydrogen sulfide, more typically about 1×10⁻³ wt %, about 5×10⁻³ wt %, about 0.01 wt %, about 0.05 wt %, about 0.1 wt %, about 0.5 wt %, about 1 wt %, about 5 wt %, about 10 wt %, about 20 wt %, about 30 wt %, about 40 wt %, about 50 wt %, about 60 wt %, about 70 wt %, and about 80 wt % hydrogen sulfide.

Typically, the contacting temperature is from about −10° C. to about 200° C. and more typically the contacting temperature is from about 0° C. to about 80° C. The rate of addition of the hydrogen sulfide fluid 105 to the enclosed vessel typically varies from about 0.01 gallon/minute to about 2500 gallons/minute, more typically from about 0.1 gallon/minute to about 100 gallons/minute, and even more typically from about 0.5 gallon/minute to about 10 gallons/minute.

In step 106, the contacted mixture 103 is separated into a sulfur-containing mixture 110 and at least one of a non-aqueous liquid phase 108 or a gas phase 107. The separation step 106 is typically conducted in the same enclosed vessel where the contacted mixture 103 is formed. In another embodiment, formation of contacted mixture 104 is conducted in one vessel and the separation step 106 is conducted in another vessel. The separation step 106 is typically conducted in any phase separator vessel commonly known within the art. Three-phase separator vessels commonly utilized within the petroleum and/or natural gas industries are preferred. The gas phase 107 typically contains natural gas and little, if any, hydrogen sulfide and is suitable for transport by a natural gas pipeline. The non-aqueous liquid phase 108 is typically liquid petroleum products, substantially free of hydrogen sulfide and water and suitable for transport by a pipeline and/or tanker.

In an optional separation step 109, the sulfur-containing mixture 110 is separated into a sulfur-containing material 111 and an aqueous phase 112. The sulfur-containing material 111 contains substantially most or all of the sulfur-containing reaction products. In a preferred embodiment, the sulfur-containing material 111 substantially comprises a sulfate salt (in the form of a precipitate). In a more preferred embodiment, the sulfur-containing material 111 comprises potassium sulfate. Commonly, the aqueous phase 112 comprises a brine. In a preferred embodiment, the aqueous phase 112 comprises water.

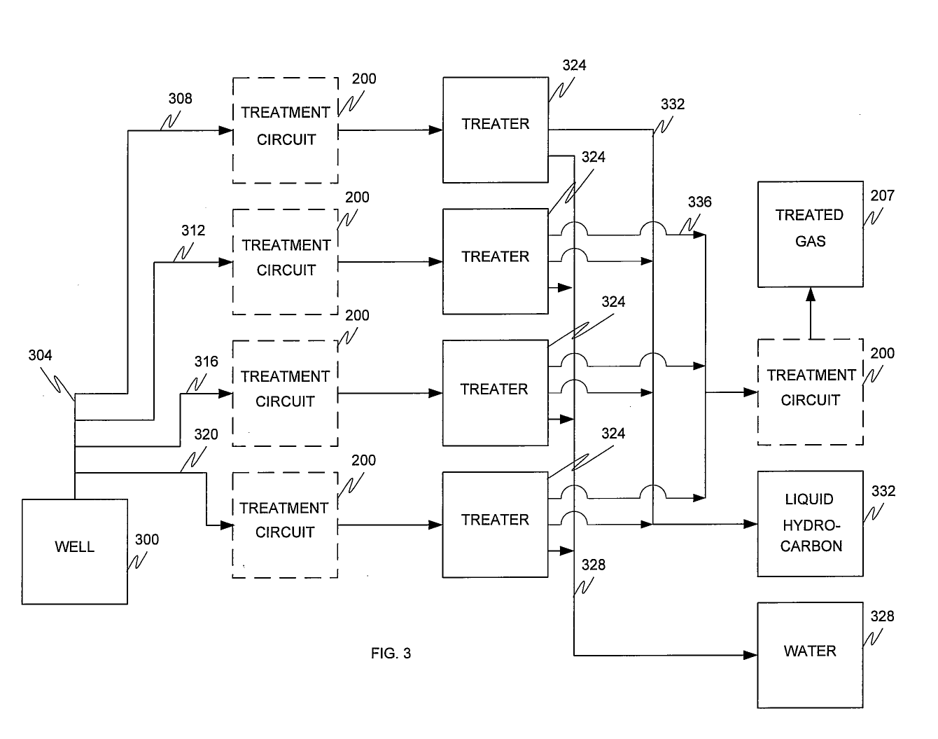

FIG. 3 depicts a treatment system according to another embodiment. The treatment system includes a well 300, which may be a hydrocarbon gas or liquid production well. A christmas tree 304 on the well 300 produces several fluid streams 308, 312, 316, and 320. While each stream is a mixture of liquid hydrocarbons, water and gas-phase components, the first fluid stream 308 comprises predominantly heavier liquid hydrocarbons and water, the second fluid stream 312 lighter liquid hydrocarbons and water, the third fluid stream 316 heavier gas phase hydrocarbons, and the fourth fluid stream 320 lighter gas phase hydrocarbons (particularly methane). Hydrogen sulfide may be present in all of these streams in either the liquid or gas phases. In one process configuration, one or more of these fluid streams is contacted with the treatment circuit 200 to convert preferably at least most and even more preferably at least about 75% of the hydrogen sulfide into a sulfur-containing material 110 and form a treated gas stream that is substantially free (e.g., contains no more than about 10 ppm of hydrogen sulfide). In another process configuration, the various streams 308, 312, 316, and 320 are provided to a treater 324, each of which fractionates the stream into water 328, liquid hydrocarbons 332, and a hydrocarbon-containing gas 336. In one process configuration, the gas 336 is treated by the treatment circuit 200 to form a treated gas 207 that is substantially free of hydrogen sulfide.

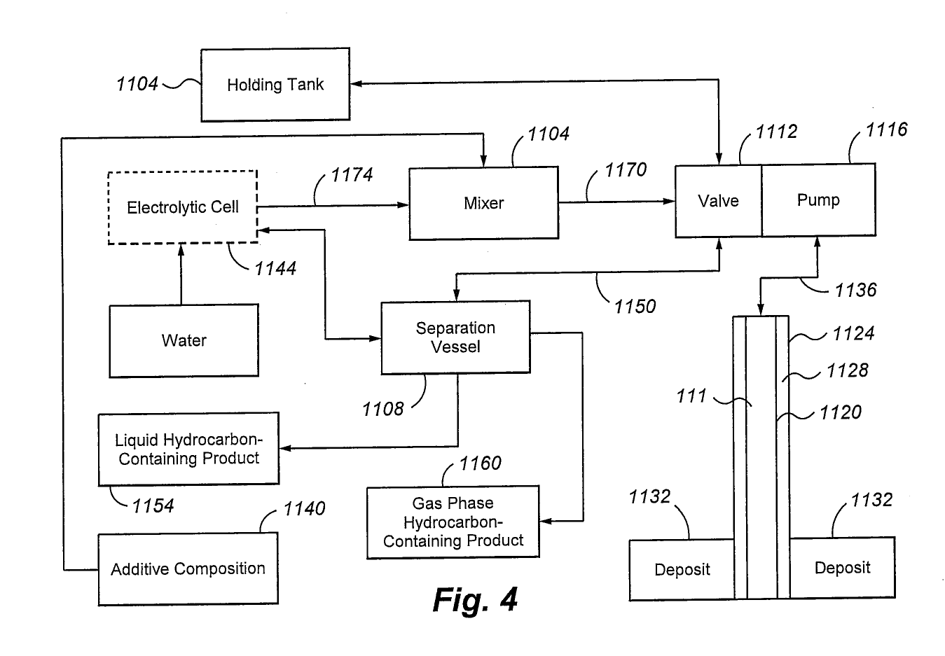

FIG. 4 depicts a process configuration according to an embodiment. The process configuration includes a mixer 1100, holding tank 1104, separation vessel 1108, valve 1112, and pump 1116. The pump 1116 pressurizes and introduces into the well 100 a liquid additive composition. The well can have any configuration but typically includes an inner and outer tubing string 1120 and 1124 forming an annulus 1128 and internal volume 111. The annulus 1128 and internal volume 111 are in fluid communication with a hydrocarbon-containing formation 1132. In one application, hydrogen sulfide is present in the annulus 1128 and/or internal volume 111 and/or the perforations in the tubing strings 1120 and/or 1124 and/or in the pores and/or fractures of the formation 1132.

These and other problems are addressed by the additive composition. To form the liquid additive composition, the additive composition 1140, which is in the form of a free flowing powder, is mixed in mixer 1104 with water. The mixer 1104 preferably is a stirred tank vessel.

The water can be from any suitable water source, such as a surface body of water, a subsurface body of water, with an aquifer being exemplary, or the well 100 itself. The well 100 produces produced water, which is recovered in the separation vessel 1108 as discussed below. Produced water typically includes not only water but also various salts, such as potassium chloride, sodium chloride, and sodium carbonate.

The water is optionally treated by one or more electrolytic cells 1144 to impart an added electron, or negative charge, to the water molecule. The negative charge is believed to enhance the effectiveness of the liquid additive composition in solubilizing hydrocarbons. While any electrolytic cell may be employed, preferred cells include ionizing and chloralkali cells. As will be appreciated, the ionizing cell, unlike the chloralkali cell has no semi-permeable membrane positioned between the anode and cathode. While not wishing to be bound by any theory, the electric current passing through the cell is believed not only to impart an added electron to the water molecule but also to convert some water molecules into hydrogen gas and hydroxyl ions and alkali metal chloride salts into alkali metal hydroxides and chloride gas. A vapor recovery system collects the chlorine and hydrogen gases as separate products. The hydrogen gas may be added to any gaseous hydrocarbons (e.g., natural gas) recovered from the well 100.

In the mixer, the additive composition is mixed with the ionized water 1174 to form a liquid additive composition 1170. In one formulation, the liquid additive composition 1170 comprises from about 0.1 to about 0.3 wt. % of a peroxygen compound, from about 0.15 to about 0.4 wt. % of a silicate, from about 0.1 to about 0.3 wt. % of a builder, from about 0.001 to about 0.002 wt. % of a surfactant, and from about 0.001 to about 0.003 wt. % of a chelate. The liquid additive composition has a preferred pH in the range of from about pH 12 to about pH 13. The liquid additive composition typically has an oxidation potential of at most about −100 mV versus SHE and/or a surface tension commonly of at most about 30 dynes. Additionally, the liquid additive composition typically has a Na₂O milliequivalent (meq) value at a pH of about pH 8 of at least about 20 meq.

The liquid additive composition 1170 is removed from the mixer 1104 and passed, via valve 1112 and pump 1116, into either the annulus 1128 or internal volume 111 of the well 100. The liquid additive composition may be pumped out of the well 100 and directed, by valve 1112, to a holding tank 1104 and then pumped back into the well 100. This process may be repeated in a number of cycles as desired.

While in the well 100, the liquid additive composition solubilizes and removes hydrocarbons, such as oil, paraffins, alphaltenes, kerogen, malthas, gilsonites, tars, bitumen; and/or mixtures thereof and reacts with and neutralizes hydrogen sulfide. The hydrocarbon dissolving properties of the liquid additive composition are discussed at length in copending U.S. application Ser. No. 12/487,484, filed Jun. 18, 2009, and entitled “A COMPOSITION COMPRISING PEROXYGEN AND SURFACTANT COMPOUNDS AND METHOD OF USING THE SAME” and which is incorporated fully herein by this reference. The hydrocarbon-containing liquid additive composition, including the solubilized hydrocarbons, is removed by pump 1116 and directed, by valve 1112, to the separation vessel.

The hydrocarbon-containing liquid additive composition includes a number of different components. It normally includes the water carrier, additive composition, various salts (such as alkali metal chlorides and carbonates), solubilized liquid- and gas-phase hydrocarbons (e.g., oil, paraffins, asphaltenes, kerogen, bitumen, lead pellets, calcium salt, and other substances that may have caused well skin damage), the sulfur-containing material, and other compounds and particulates. In a typical application, the amount of hydrocarbons dissolved in the composition is at least about 6 wt. % and even more typically ranges from about 8 to about 10 wt. %.

In the separation vessel 1108, the gas-phase hydrocarbons are vented off as a gas-phase hydrocarbon-containing product 1160 (which may be combined with hydrogen gas produced by the electrolytic cell 1144) and the remainder of the hydrocarbon-containing liquid additive composition 1150 is permitted to fractionate into three layers. The upper layer comprises at least most of the lighter hydrocarbons, including oil, paraffins, bitumen, and kerogen, in the composition 1150, the middle at least most of the dissolved additive composition and produced water in the composition 1150, and the lower layer at least most of the heavier hydrocarbons, including asphaltenes, and solid-phase components, such as particulates and the sulfur-containing material.

A wax float can further concentrate lighter hydrocarbons in the upper layer.

The various phases can be removed separately from the separation vessel 1108 to form a hydrocarbon-containing product 1154 containing at least most of the hydrocarbons in the composition 1150. The product 1154 can be further processed by known techniques to form concentrated fractions of the various hydrocarbons.

The middle layer containing the additive composition and produced water is recycled to the electrolytic cell 1144. As needed, additional additive composition and/or components thereof are added to the mixer to maintain desired concentration levels of the various composition components.

### EXPERIMENTAL

One-hundred pounds of the above additive composition was added to 200 gallons of water heated to 170° F. to form a liquid additive composition. This composition was placed down hole in a oil/gas well for a period of 24 hours. After that time, the reacted liquid additive composition was pumped out of the well. The reacted liquid additive composition was an aqueous sludge containing 10 barrels of paraffin and having a bio-film formation. Once this was removed, the well had a 100% increase in production. The hydrogen sulfide content of the produced hydrocarbons went from 25 ppms to under 2 ppms.

After several weeks, the well remained at a 100% increase in production (relative to the well before contact with the liquid additive composition), and the produced hydrocarbons had hydrogen sulfide content still under 2%. As for the bio-film, it is unknown whether the liquid additive composition killed completely, or simply removed from the well, the biological microbes.

A number of variations and modifications of the invention can be used. It would be possible to provide for some features of the invention without providing others. The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and\or reducing cost of implementation.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
a) forming a liquid additive composition comprising a peroxygen component and a neutralization component;
b) contacting the liquid additive composition with a hydrogen sulfide-containing fluid to form a contacted mixture comprising a sulfur-containing material derived from a reaction of the peroxygen component and the hydrogen sulfide; and
c) separating the contacted mixture to form a sulfur-containing mixture and at least one of a gas phase and a non-aqueous liquid phase.

2. The method of claim 1, wherein the hydrogen sulfide-containing fluid comprises a hydrocarbon, wherein the hydrogen sulfide-containing fluid comprises from about 5 to about 25,000 ppm/ft³ hydrogen sulfide, and wherein the peroxygen component is selected from the group consisting of peroxides, persulfates, thiourea dioxides, percarbonates, perborates, diethylhydroxylamines, peracetic acids, superoxides, and mixtures thereof.

3. The method of claim 2, wherein the hydrogen sulfide-containing fluid comprises from about 5 to about 75 mole % methane and the hydrocarbons, ethane, propane, iso-butane, n-butane, iso-pentane, n-pentane, and n-hexanes.

4. The method of claim 2, wherein the liquid additive composition comprises from about 0.1 to about 95 wt % of the peroxygen compound.

5. The method of claim 2, wherein the neutralization component is a Lewis and/or Brønsted-Lowery base and wherein the liquid additive composition comprises from about 0.1 to about 95 wt. % of the neutralization component.

6. The method of claim 1, wherein the peroxygen component converts at least most of the hydrogen sulfide into a sulfur compound other than hydrogen sulfide.

7. The method of claim 6, wherein the sulfur compound comprises hydrosulfuric acid and wherein the neutralization component converts at least most of the hydrosulfuric acid into a sulfate.

8. The method of claim 1, wherein the liquid additive composition has an oxidation potential of at most about −100 mV versus a standard hydrogen electrode, a pH of at least about pH 11, and a surface tension of at most about 28 dynes.

9. The method of claim 8, wherein the liquid additive composition is formed from an additive composition and wherein the additive composition comprises at least about 20 wt. % alkalis, at least about 25 wt. % of the peroxygen component, at least about 15 wt. % of a silicate, from about 5 wt. % of a hydrated builder, at least about 0.01 wt. % of a surfactant, and at least about 2 wt. % of a chelate.

10. The method of claim 1, wherein the liquid additive composition comprises a surfactant and wherein the surfactant comprises at least one of a quaternary amine, an alkane sulfonate, a block copolymer alcohol, a propylene oxide and ethylene oxide block copolymer, nonylphenoxypoly(ethyleneoxy) ethanol, and octylphenoxypoly (ethyleneoxy) ethanol.

11. The method of claim 1, wherein the liquid additive composition comprises a first surfactant having an HLB value of less than about 8 and a second surfactant having an HLB value greater than about 10.

12. The method of claim 1, wherein the liquid additive composition comprises a fluorocarbon surfactant.

13. The method of claim 9, wherein a weight ratio of the peroxygen component to the chelate ranges from about 3:1 to about 7:1, a weight ratio of the silicate to the surfactant ranges from about 5:1 to about 15:1, a weight ratio of the silicate to the peroxygen component ranges from about 1:1 to about 2:1, and a weight ratio of the silicate ranges from about 5:1 to about 15:1.

14. The method of claim 1, wherein a molar ratio of the peroxygen component to the hydrogen sulfide is from about 0.5 to about 10.

15. A system, comprising:
a source of a hydrocarbon- and hydrogen sulfide-containing fluid; and
a treatment circuit to contact the fluid with a peroxygen compound to form a treated fluid in which at least most of the hydrogen sulfide has been converted into a sulfur-containing material other than hydrogen sulfide.

16. The system of claim 15, wherein the treatment circuit is located between the well and a treater.

17. The system of claim 15, wherein the treatment circuit is located downstream of a treater.

18. The system of claim 15, wherein the treatment circuit comprises a scrubber comprising a liquid additive composition, the liquid additive composition comprising the peroxygen component and a neutralization component and wherein the treated fluid is substantially free of hydrogen sulfide.

19. A system, comprising:
a well containing hydrocarbons and hydrogen sulfide; and
a liquid additive composition in the well, the liquid additive composition comprising a peroxygen compound to convert the hydrogen sulfide into a sulfur-containing material other than hydrogen sulfide and form a treated fluid.

20. The system of claim 19, wherein the liquid additive composition comprises water and further comprising:
an electrolytic cell to impart an electrical charge to the water molecules.

21. The system of claim 19, further comprising:
a separation vessel to remove hydrocarbons from the treated fluid.

22. A liquid composition, comprising:
at least about 5 wt. % of hydrocarbons;
at least about 0.001 wt. % peroxygen compound; and
at least about 5 ppm of hydrosulfuric acid.

23. The composition of claim 22, further comprising:
at least one of a sesquisilicate and metasilicate;
a surfactant; and
a chelate.

24. The composition of claim 23, further comprising a hydrated builder.

25. The composition of claim 22, further comprising at least about 0.001 wt. % of at least one of a Lewis and/or a Brønsted-Lowry base.
